(19) United States
(12) Patent Application Publication
(10) Pub. No.: US 2005/0095079 A1
(43) Pub. Date: May 5, 2005

(54) Eye bolt

(76) Inventor: Ludwig Beckers, Weeze-Wemb (DE)

Correspondence Address: WILLIAM COLLARD;COLLARD & ROE, P.C., 1077 NORTHERN BOULEVARD, ROSLYN, NY, 11576, US

(21) Appl. No.: 10/973,674

(22) Filed: Oct. 26, 2004

(30) Foreign Application Priority Data
Nov. 3, 2003 (DE) 203 16 970.0
Jul. 9, 2004 (DE) 10 2004 033 193.6

(51) Int. Cl. F16B 21/00

(52) U.S. Cl. 411/348

(57) ABSTRACT

A fastening element in the form of an eye bolt, which has a ring body encompassing a ring opening. The ring body is connected with an end area of a fastening bolt, which has, at a distance from said end area, in its fastening position, balls with a part of their surface protruding from the surface shell of the fastening bolt. The balls are held in their fastening position by a bolt element guided within the fastening bolt. The bolt element is axially longitudinally moveable against the force of a spring and is intended to provide a solution which improves the characteristics of use and handling of such an actuation element. This is achieved by the fact that the ring body is extended in the manner of a shackle beyond its ring opening and the end area of the fastening bolt is fixed so as to pivot between the shackle ends.

### BACKGROUND OF THE INVENTION

1. Field of the Invention

The invention relates to a fastener in the form of an eye bolt, which has a ring body encompassing a ring opening, said ring body being connected with an end area of a fastening bolt. The fastening bolt has balls with a part of their surface protruding from the surface shell of the fastening bolt, the balls being held in their fastening position by means of a bolt element guided within the fastening bolt. The bolt element is axially longitudinally moveable against the force of a spring. The invention also relates to a fastening system consisting of the fastening element and an engaging and disengaging sleeve receiving the fastening bolt with an inner groove adapted to the dimension of the spherical areas protruding from the surface shell of the fastening bolt.

2. The Prior Art

Such fastening elements and fastening systems are known as “removable anchorage points”. The sleeve usually has an external thread and is screwed, for example, into a plug let into brickwork. The fastening bolt of the eye bolt can be guided into this sleeve and locked into it by snapping in the spherical surfaces into the inner groove running around the inside of the sleeve. In this locked position, a rope can be passed through the ring opening, where a carabiner can be fixed or where other safety or fastening elements can be fastened. In this way, fixing or anchorage points can be placed in walls or brickwork more or less at will. The eye bolt also has an element which can be moved longitudinally axially against the force of a spring, with the aid of which element the force of pressure pressing the spherical surfaces into the inner groove varies or can be removed completely. In the last-mentioned actuation position of the fastening element the eye bolt can then be withdrawn from the sleeve and the sleeve can also be sealed with a plastic cap. In this respect, the fixing or anchorage point is removable.

A generic fastening element and a generic fastening system are known under the brand name of SALA®. The known fastening element consists of a ring body with a grip reinforcement attached in the ring body. This grip reinforcement is fitted with a through-bore having an inner thread, into which bore an end area of the fastening bolt provided with an outer thread is screwed. At the opposite end area of the fastening bolt there are four balls distributed over the perimeter of the fastening bolt with a part of their surface protruding from the surface shell of the fastening bolt. The balls are held in this locking position by means of a bolt element which is guided within the fastening bolt and axially longitudinally moveable against the force of a spring. The bolt element is made in the form of a connecting rod and with its handling head, which can be grasped by the user, in the area of the end area of the fastening bolt disposed in the grip reinforcement of the ring body, protrudes beyond this and extends into the ring opening of the ring body. The connecting rod can be partially drawn out of the fastening bolt against the force of a spring in the direction of the center point of the ring opening of the ring body. This causes the balls disposed in the surface shell of the fastening bolt to come free to the extent that they are no longer being forced outwards, such that they can move in the direction of the longitudinal axis of the fastening bolt. In this position, the fastening bolt is now inserted into a sleeve which has an inner bore adapted to the outer diameter of the surface shell of the fastening bolt, which bore has a circumferential inner groove adapted to the position of the balls on the surface shell of the fastening bolt and their dimensions.

In its locking position, inserted into the sleeve, the balls of the fastening bolt are disposed at the level of the inner groove and, as soon as the user releases the handling head of the connecting rod and this is fully drawn back into the fastening bolt by means of the force of a spring, are firmly pressed into the inner groove. In this way, the eye bolt is then fixed in the sleeve, but also removable, by taking out the connecting rod again and the balls of the fastening bolt thereby release their stop position in the inner groove.

The disadvantage of this state of the art is that the handling head of the connecting rod protrudes into the ring opening of the eye bolt. The result of this is that any rope passed through this ring opening while in use or a carabiner hooked into this ring chafes against the handling head. This can damage the rope or carabiner, and can also lead to damage to the handling head and thus the function of the connecting rod will be affected. The user must also grasp hold of the handling head, in order to actuate it, in its position inside the ring body and possibly also hold onto it in the withdrawn position. This is relatively uncomfortable, since the ring body surrounding the ring opening hampers this grip and pull movement.

### SUMMARY OF THE INVENTION

The invention is therefore based on the problem of creating a solution which improves the characteristics of handling and of use of generic fastening elements and fastening systems.

In a fastening element and fastening system of the aforementioned type the problem is solved according to the invention by the fact that the ring body is extended outside its ring opening in the manner of a shackle and the end area of the fastening bolt is fixed so that it can pivot between the shackle ends.

The result of this is, firstly, that the ring opening in which for example a carabiner is to engage when in use, or through which a safety rope is guided, is not interfered with by any building component or structural member over its entire free cross-section area. The end area of the fastening bolt which is to be actuated, i.e. to release the stop lock, lies outside the ring body and is protected between the two shackle ends and the outer area of the ring body which lies between them. This means that damage can no longer occur, and the handling or actuation area of the fastening bolt can no longer be damaged by a rope passed through the ring opening or a carabiner engaging in the ring opening. But this also means that larger carabiners can be used which otherwise could not be, due to a building component or structural member of the fastening element protruding into the ring opening.

Finally, the construction according to the invention allows the use of materials and construction elements which can either be constructed more strongly while the fastening element has the same external dimensions, or, again with the same dimensions, display greater mechanical stability, so that with the fastening element according to the invention with dimensioning which is otherwise identical or nearly identical, the weight of three persons can be supported, while the constructions according to the state of the art are designed only for the weight of one person. In addition to this, due to the freedoms resulting from the construction according to the invention, the ring body can be designed more elegantly and be more finely detailed, so that the fastening element has a more attractive appearance.

In one embodiment, the fastening bolt is fixed to the ring body by means of a rod-shaped or pin-shaped fastening element part which punches through the end area and openings in the shackle ends. A bolt or pin or rod which punches through both the end area of the fastening bolt and the areas of the shackle ends acts as a structurally simple measure to realize the invention.

It is especially advantageous for the handling and use of the fastening element if the balls can be brought by longitudinal axial movement of the bolt element as the result of a pressure force exerted thereon, out of their fastening position into an unlocking position, for which the invention also makes provision. In this case, the “removable anchorage point” can be released from its locked position in the sleeve because a pressure is exerted on the fastening bolt, thus a force in the direction of the sleeve. This also increases safety since any pulling movement on the fastening element or on the fastening bolt does not lead to a release of the locking mechanism between fastening bolt and sleeve.

In another embodiment, the anchoring clip part is the thread part of a screw, which is fixed to the shackle ends by means of a self-locking nut.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a fastening element according to the invention in lateral view;

FIG. 2 shows a lateral view of a sleeve in partially sectioned form and

FIG. 3 shows the sleeve in position of use with assigned fastening element.

### DETAILED DESCRIPTION OF THE PREFERRED EMBODIMENT

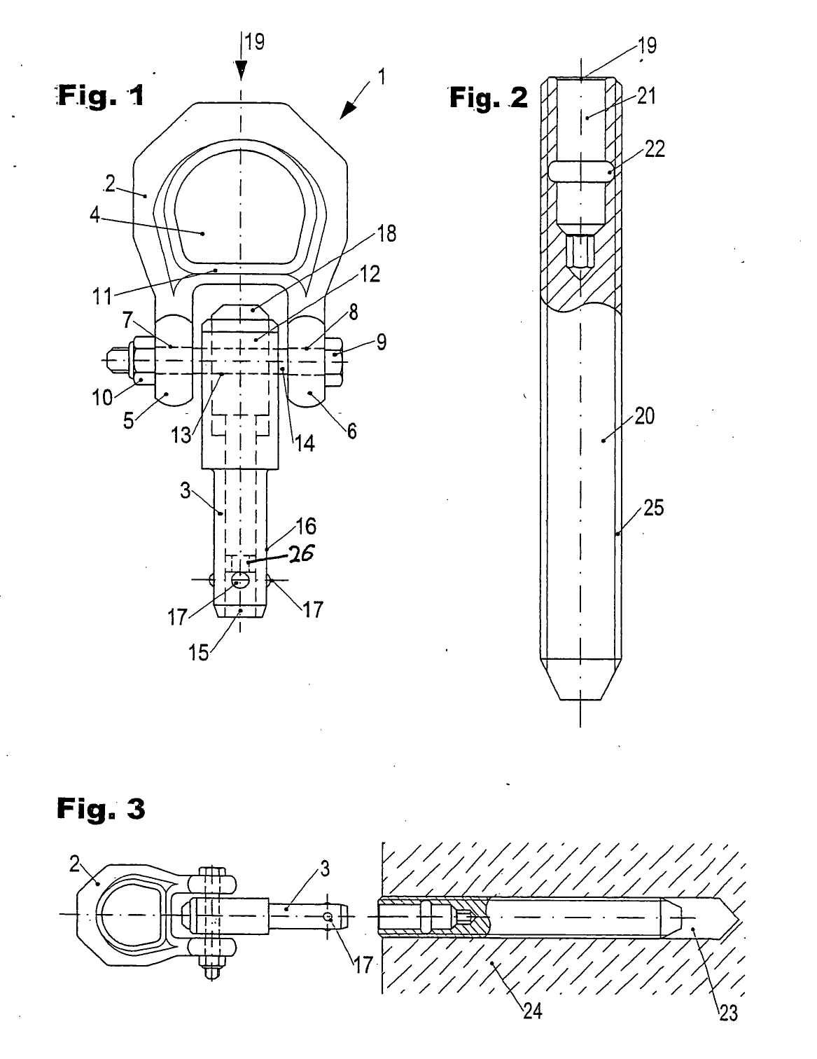

The fastening element referred to as a whole in FIG. 1 as 1, in the form of an eye bolt, comprises a ring body 2 and a hollow fastening bolt 3. Ring body 2 encompasses or encircles a ring opening 4 and is extended in the manner of a shackle externally on one side outside the ring opening 4 by shackle ends 5, 6. In shackle ends 5, 6, bores 7, 8 are formed through which a cap screw 9 is passed and is screwed tight at the end opposite the screw head with a self-locking nut 10. An end area 12 of fastening bolt 3 is disposed in the space framed by shackle ends 5, 6 and a cross-strut 11 of ring body 2. This end area 12 has a cross hole 13, through which cap screw 9 with its rod-shaped or pin-shaped fastening element part 14 punches. In its end area 15 located opposite end area 12, fastening bolt 3 has symmetrically-disposed openings on one perimeter area of its surface shell 16, through which balls 17 protrude with a part of their surface from the surface shell 16 of the fastening bolt 3. The remainder of the balls 17 disposed in this area, which is at a distance from end area 12, are located within fastening bolt 3 and are held in the position shown in FIG. 1, which represents their locking position, by means of a bolt element, shown by a dotted line, which can move within the fastening bolt longitudinally axially against the force of a spring (not shown). By exerting pressure on the handling or actuation head 18 of fastening bolt 3 or the bolt element in the direction of the arrow 19, the bolt element which has a cross-opening in the form of a longitudinal hole at the level of cross hole 13 is moved against the force of a spring, not shown, into a position in which a section 26 of the bolt element no longer holds balls 17 in their locking position, so that these can fall back into the interior of the fastening bolt 3.

In such an unlocking position, fastening bolt 3 can be inserted with its end area 15 into an opening 19 in a sleeve 20, as shown in FIG. 2. There is an inner bore 21 formed within sleeve 20 in its upper area, which is provided with a circumferential inner groove 22 or slot. The dimensions of inner groove 22 are adapted to the form of balls 17 such that when end 15 is inserted into inner bore 21 the balls snap into groove 22, as soon as they have attained the position of the groove 22 and the actuation head 18 is released. At the moment at which the balls 17 come to rest in or snap into the groove 22, the fastening element 1 is locked into the sleeve 20. Usually the sleeve 20 is located at that time in a bore 23 in brickwork 24. In such cases, there can also be a plug provided in bore 23, into which plug sleeve 20 which is embodied as a whole as a threaded rod with an external thread 25 is screwed. In order to screw sleeve 20 into a bore 23 or a plug, in the bottom of bore 21 there is a further polygonal blind bore in the form of a inner hexagon in which an Allen key can engage as screwdriver.

If the fastening element is to be removed from sleeve 20, out of its locking position, again a pressure in the direction of arrow 19 is exerted on the handling or actuation head 18, whereby the pressure in alternative embodiments can also be applied by corresponding actuation of ring body 2, so that the balls 17 can retract from their locking position in groove 22 into the interior of fastening bolt 3 and fastening bolt 3 can be withdrawn from sleeve 20.

Accordingly, while only a few embodiments of the present invention have been shown and described, it is obvious that many changes and modifications may be made thereunto without departing from the spirit and scope of the invention.

List of Reference Numbers

1 fastening element
2 ring body
3 fastening bolt
4 ring opening
5, 6 shackle ends
7, 8 bore
9 cap screw
10 nut
11 cross-strut
12 end area (of 3)
13 bore
14 fastening element part
15 end area
16 surface shell
17 ball
18 handling or actuation head
19 opening
20 sleeve
21 inner bore
22 inner groove
23 bore
24 brickwork
25 outer thread
26 section

1. A fastening element comprising;
a ring body encompassing a ring opening;
a fastening bolt, said ring body being connected with an end area of said fastening bolt;
balls disposed at a distance from said end area, said balls having a part of their surface protruding from a surface shell of the fastening bolt;
a bolt element guided within the fastening bolt, said bolt element being axially longitudinally moveable against a force of a spring and said bolt element holding the balls in a fastening position,
wherein the ring body is extended outside of the ring opening in the manner of a shackle, and the end area of the fastening bolt is fastened so as to swivel between ends of the shackle.

2. The fastening element according to claim 1, wherein the fastening bolt is fastened to the ring body by means of a rod-shaped or pin-shaped fastening element part punching through the end area and openings in the shackle ends.

3. The fastening element according to claim 1, wherein the balls may be brought from the fastening position into an unlocking position by longitudinal axial movement of the bolt element as the result of a pressure exerted thereon.

4. The fastening element according to claim 1, wherein the fastening element is the threaded part of a screw.

5. The fastening element according to claim 1, wherein the screw is fastened by means of a self-locking nut onto the shackle ends.

6. A fastening system comprising:
a fastening element, comprising:
a ring body encompassing a ring opening;
a fastening bolt, said ring body being connected with an end area of said fastening bolt;
balls disposed at a distance from said end area, said balls having a part of their surface protruding from a surface shell of the fastening bolt;
a bolt element guided within the fastening bolt, said bolt element being axially longitudinally moveable against a force of a spring and said bolt element holding the balls in a fastening position; and
an engaging and disengaging sleeve receiving the fastening bolt with a circumferential inner groove adapted to a dimension of the balls protruding from the surface shell of the fastening bolt, wherein
wherein the ring body is extended outside of the ring opening in the manner of a shackle, and the end area of the fastening bolt is fastened so as to swivel between ends of the shackle.

7. A fastening system according to claim 6, wherein the balls may be brought from the fastening position into an unlocking position by longitudinal axial movement of the bolt element as the result of a pressure exerted thereon.
